(19) United States
(12) Patent Application Publication
(10) Pub. No.: US 2009/0112520 A1
(43) Pub. Date: Apr. 30, 2009

(54) SELF-AWARE SEMICONDUCTOR EQUIPMENT

(75) Inventors: DIMITRIS LYMBEROPOULOS, San Jose, CA (US); Robin Cheung, Cupertino, CA (US)

Correspondence Address: MOSER IP LAW GROUP / APPLIED MATERIALS, INC., 1030 BROAD STREET, 2ND FLOOR, SHREWSBURY, NJ, 07702, US

(73) Assignee: APPLIED MATERIALS, INC., Santa Clara, CA (US)

(21) Appl. No.: 11/929,338

(22) Filed: Oct. 30, 2007

(51) Int. Cl. G06F 15/00

(52) U.S. Cl. 702/184

(57) ABSTRACT

The present invention provides methods and apparatus for predictive maintenance of semiconductor process equipment. In some embodiments, a method for performing predictive maintenance on semiconductor processing equipment includes performing at least one self-diagnostic test on the semiconductor processing equipment with no substrate present in the equipment; comparing a result of the at least one self diagnostic test to at least one baseline characterization of the equipment; and determining whether equipment maintenance is required based upon the comparison.

### BACKGROUND

1. Field

Embodiments of the present invention generally relate to semiconductor processing equipment, and, more specifically, to semiconductor processing equipment having predictive maintenance capabilities.

2. Description

Predictive maintenance, as opposed to preventive maintenance, has been the subject of many discussions and conferences in the semiconductor industry. The objective of using data from a processing tool to assess the state of the tool and its need for maintenance has been long pursued. However, the multitude of recipes being used on any given tool, and thus, the amount of effort required to characterize the behavior of the tool over time, presents a huge obstacle to efficiently and effectively implement equipment that suitably meets this objective.

For example, typically, on-wafer performance of the process tool on a frequent basis (for example, every shift) has been utilized in the attempt to continually tune the process tool prior to committing a batch of wafers for processing. However, the effort required to characterize tool behavior as a function of time depending upon the recipes being used and/or the mix of recipes being used presents a prohibitive obstacle to the successful implementation of predictive maintenance.

Thus, there is a need for semiconductor equipment having effective predictive maintenance capabilities.

### SUMMARY

The present invention provides methods and apparatus for predictive maintenance of semiconductor process equipment. In some embodiments, a method for performing predictive maintenance on semiconductor processing equipment includes performing at least one self-diagnostic test on the semiconductor processing equipment with no substrate present in the equipment; comparing a result of the at least one self diagnostic test to at least one baseline characterization of the equipment; and determining whether equipment maintenance is required based upon the comparison.

In some embodiments, a computer readable medium is provided. The computer readable medium having instructions stored thereon that, when executed by a processor, cause the processor to perform a method for predictive maintenance of semiconductor process equipment including performing at least one self-diagnostic test on the semiconductor processing equipment with no substrate present in the equipment; comparing a result of the at least one self diagnostic test to at least one baseline characterization of the equipment; and determining whether equipment maintenance is required based upon the comparison.

In some aspects of the invention a system for processing semiconductor substrates is provided. In some embodiments, a system for processing semiconductor substrates includes a process chamber; and a controller coupled to the process chamber and configured to control the operation thereof, wherein the controller comprises computer readable medium having instructions stored thereon that, when executed by the controller, cause the controller to perform a method for predictive maintenance of the process chamber includes performing at least one self-diagnostic test on the semiconductor processing equipment with no substrate present in the equipment; comparing a result of the at least one self diagnostic test to at least one baseline characterization of the equipment; and determining whether equipment maintenance is required based upon the comparison.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a flow chart depicting a process for performing predictive maintenance in accordance with some embodiments of the invention.

FIG. 2 is a flow chart depicting a process for performing self-diagnostic testing in accordance with some embodiments of the invention.

FIG. 3 depicts an etch chamber suitable for use in connection with some embodiments of the invention; and

FIG. 4 depicts a schematic diagram of an exemplary integrated semiconductor substrate processing system (e.g., cluster tool) of the kind suitable for use in connection with some embodiments of the invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention provide apparatus capable of performing predictive maintenance and methods for performing predictive maintenance on the apparatus. The apparatus may be any suitable processing apparatus as described in more detail below, such as semiconductor processing equipment. The method may be stored in the memory of a controller configured to control the apparatus. The methods and apparatus of the present invention facilitates the implementation of predictive maintenance in a manageable fashion by using a limited number (one or more) of waterless recipes or other instructions to help capture the overall tool dynamics and characterize tool performance over time. The characterized tool performance may be compared to a baseline characterization for a particular tool to determine whether maintenance is required. The recipe(s), or instructions, can be run automatically (e.g., invoked by the tool) and/or run manually (e.g., invoked by the operator).

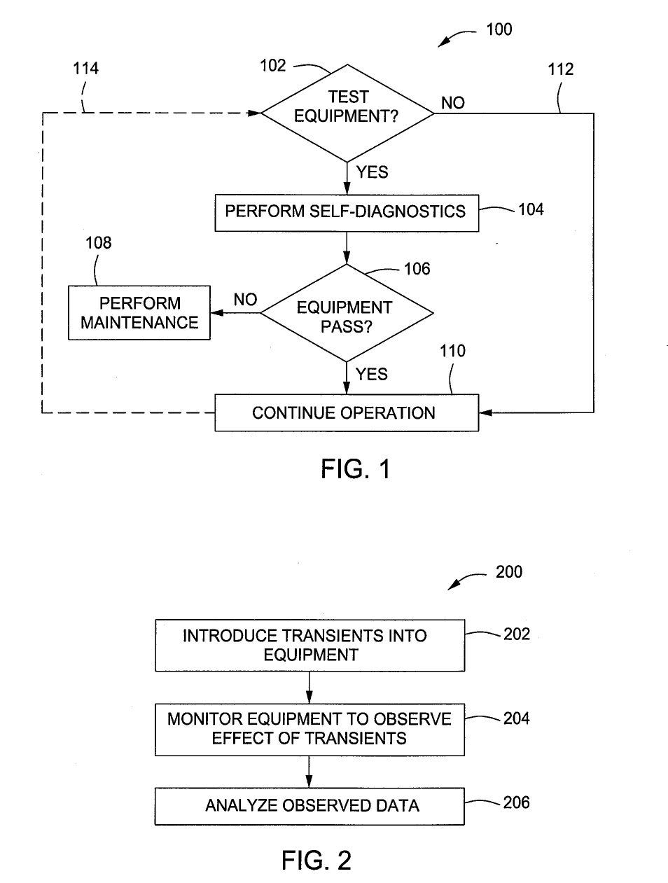

FIG. 1 is a flow chart depicting a predictive maintenance process 100 in accordance with some embodiments of the present invention. The process 100 may be stored in memory of a controller of one or more pieces of process equipment (such as a process chamber as discussed below). The process 100 begins at 102, where a decision may be made regarding whether or not to test the equipment. The decision to test the equipment may be made at any desired stage of the semiconductor manufacturing process, such as based upon actual time elapsed between checks, equipment runtime elapsed, prior to introducing the first wafer into the equipment, between processing each wafer in the equipment, between processing wafer lots in the equipment, shift-to-shift changes of operators, between making changes in the process conditions in the equipment, after chamber clean processes or other maintenance of the equipment, or at any other time deemed desirable. The decision at 102 may be made automatically (e.g., invoked by the tool) and/or run manually (e.g., invoked by the operator) at any suitable or desirable time, such as during equipment idle time.

If a decision is made not to test the equipment, the equipment may continue operation as shown by line 112 leading to block 110. The equipment may continue to operate until the query of whether to test the equipment is made (as shown by dashed line 114 leading back to decision block 102). If a decision is made to test the equipment, a self-diagnostic test may be performed on the equipment (as depicted at 104). The self-diagnostic test may include at least one of direct or indirect measurements of aspects of performance of the equipment. The direct and/or indirect measurements of performance may be obtained by introducing and observing the effects of transients in the equipment. In some embodiments, the measurements may include the measurement of one or more of a chamber or component temperature (such as the temperature of a substrate support pedestal, electrostatic chuck, or the like), an RF power (such as an RF source power or an RF bias power), RF harmonics, an electrical signal (such as a voltage, a current, a phase interaction, or the like), a gas flow rate of a gas introduced into the equipment (such as through a mass flow controller or the like), a pressure of an internal process volume of the equipment, or the like. In some embodiments, the measurements may be obtained directly by recording sensor data (such as thermocouples, pressure sensors, electrical sensors, or the like) and/or indirectly by recording emission monitoring (such as optical emission monitoring, or the like).

The self-diagnostic tests may be performed at 104 in a variety of ways. For example, FIG. 2 depicts a flow chart of a process 200 for performing self-diagnostic tests in accordance with some embodiments of the invention. The process 200, and variants thereof, may be utilized as at least a part of the self diagnostic test described with respect to FIG. 1 at 104. In some embodiments, the self-diagnostic measurements may be performed by introducing one or more transients into the equipment (as shown at 202). The transients may be introduced, for example, as part of instructions stored in the memory of the controller of the equipment, or manually input by the operator. The one or more transients may be introduced sequentially, concurrently, partially overlapping, sporadically, or the like. The transients may be introduced in a variety of waveforms, such as a flat or sloped line, a periodic signal (such as a square wave, sawtooth wave, sinusoidal wave, or the like), or the like. The transients may further be linear or curved and may be continuous or discontinuous. The transients may include chamber or component temperature variations (such as the temperature of a substrate support pedestal, electrostatic chuck, or the like), RF power variations (such as an RF source power or an RF bias power), RF harmonics, an electrical signal (such as a voltage, a current, a phase interaction, or the like), gas flow rates of one or more gases introduced into the equipment, process volume pressure variations, or the like, as described above.

In some embodiments, the transients may be introduced when there is no wafer present in the equipment, thereby reducing dependence upon production wafers or test wafers for the analysis of chamber performance. Eliminating the presence of the wafer also may reduce the time required for performing the test, the test variance introduced by varying wafer compositions, the risk of damage to production wafers if used, and the like.

Next, at 204, the equipment may be monitored to observe the effect of the one or more transients introduced to the equipment. The equipment may be monitored directly (such as by collection of sensor data) or indirectly (such as by collection of data obtained by emissions monitoring, such as optical spectroscopy, or the like). For example, in some embodiments, optical emission spectra can be used to characterize equipment behavior. The equipment may also be monitored by a combination of methods (such as by a plurality of sensors and/or optical emissions) that may be simultaneous or relavant to particular transients only (such as, in a non-limiting example, optical emission spectroscopy of a plasma formed in the chamber along with sensor data collection of electrical signals and temperatures within the equipment).

In some embodiments, the transients may be continually, serially, and/or sporadically introduced and monitored for a predetermined period of time sufficient to obtain desired data corresponding to equipment performance. In some embodiments, the equipment may be monitored for up to about 2 minutes. It is contemplated that other quantities of time may be utilized as desired or required to obtain the desired data.

Next, at 206, the observed data may be analyzed. In some embodiments, the observed data may be analyzed by a statistical analysis, for example, by comparing the observed data to a baseline characterization of the equipment. The baseline characterization may include one or more measurements and/or analysis of the performance of equipment that is known or presumed to be in acceptable condition, one or more modeled measurements of equipment designated as ideal (e.g., a “golden chamber”), or combinations thereof, or the like. For example, in some embodiments, optical emission spectra can be used to create signatures of how the tool is supposed to behave during transitions associated with the application of transients. In some embodiments, the analysis may compare a baseline characterization derived from optical emission spectra to optical emission spectra observed during the application of the one or more transients as discussed above. In some embodiments, the analysis may include at least one of a multivariant statistical technique such as nearest neighbor approach, principal component analysis, least square, or the like.

Returning to FIG. 1, after the self diagnostics are performed at 104 (or the process 200 for performing self-diagnostic tests), a decision may be made as to whether the equipment passes the self-diagnostic test (as depicted at 106). If the answer is yes, the equipment may continue operation, as depicted at 110 until the query to test equipment is invoked again at 102 (as depicted by dashed line 114). For example, if the analysis of the self-diagnostic measurement is within a specified tolerance range of the baseline measurement, then the equipment may continue to operate without stopping for maintenance.

If the equipment fails to pass the test (e.g., the answer to the query at 106 is no), maintenance may be performed on the equipment, as depicted at 108. For example, if the analysis of the self-diagnostic measurement falls outside of the tolerance range, then operation of the equipment may be suspended, and maintenance may be performed to return the equipment to satisfactory operating condition. Maintenance may include in situ cleaning of the equipment, adjustment, repair, or replacement of equipment components, or the like. After maintenance of the equipment is complete, the process 100 may be repeated as desired to insure that the equipment is operating satisfactorily.

As noted above, the above self-diagnostic processes may be performed manually or automatically and may be repeated or invoked at the time frames or stages of production as described above. The inventive self-diagnostic processes may be implemented in any semiconductor fabrication equipment, including (in a non-limiting example) plasma and non-plasma assisted equipment, magnetically enhanced processing equipment, thermal processing equipment, etch chambers, deposition chambers, thermal processing chambers (e.g., annealing chambers), or the like.

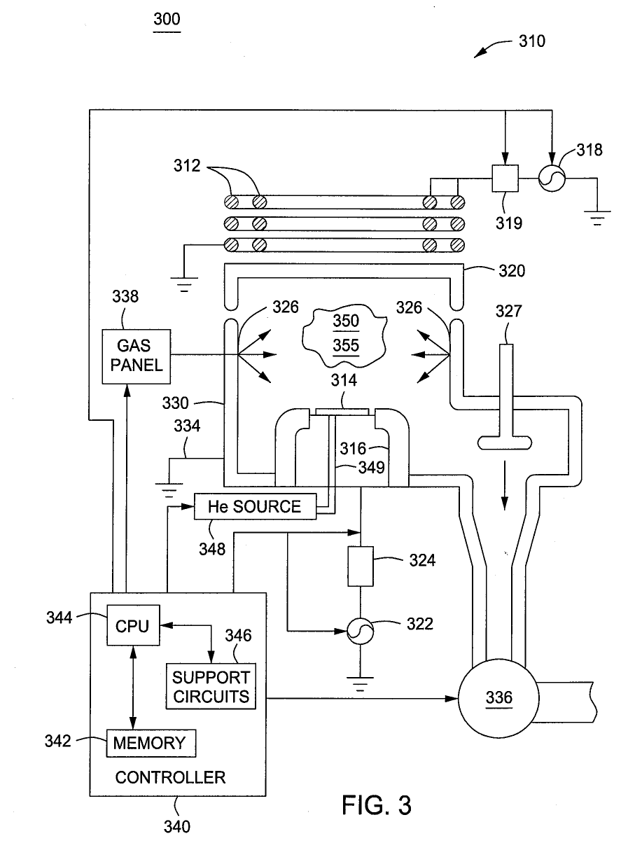

For example, FIG. 3 depicts a schematic diagram of an exemplary etch reactor 300 of the kind that may be used to practice embodiments of the invention as discussed herein. The reactor 300 may be utilized alone or, more typically, as a processing module of an integrated semiconductor substrate processing system, or cluster tool, such as a CENTURA® integrated semiconductor wafer processing system, available from Applied Materials, Inc. of Santa Clara, Calif. Examples of suitable etch reactors 300 include the DPS® line of semiconductor equipment (such as the DPS®, DPS® II, DPS® AE, DPS® G3 poly etcher, or the like), the ADVANTEDGE™ line of semiconductor equipment (such as the AdvantEdge, AdvantEdge G3), or other semiconductor equipment (such as ENABLER®, E-MAX®, or like equipment), also available from Applied Materials, Inc. The above listing of semiconductor equipment is illustrative only, and other etch reactors, and non-etch equipment (such as CVD reactors, or other semiconductor processing equipment) may suitably be used as well.

The reactor 300 comprises a process chamber 310 having a wafer support pedestal 316 within a conductive body (wall) 330, and a controller 340. The support pedestal (cathode) 316 is coupled, through a first matching network 324, to a biasing power source 322. The biasing source 322 generally is a source of up to 500 W at a frequency of approximately 13.56 MHz that is capable of producing either continuous or pulsed power. In other embodiments, the source 322 may be a DC or pulsed DC source. The chamber 310 is supplied with a substantially flat dielectric ceiling 320. Other modifications of the chamber 310 may have other types of ceilings such as, for example, a dome-shaped ceiling or other shapes. At least one inductive coil antenna 312 is disposed above the ceiling 320 (two co-axial antennas 312 are shown in FIG. 3). Each antenna 312 is coupled, through a second matching network 319, to a plasma power source 318. The plasma source 318 typically is capable of producing up to 4000 W at a tunable frequency in a range from 50 kHz to 13.56 MHz. Typically, the wall 330 may be coupled to an electrical ground 334.

During a typical operation, a semiconductor substrate, or wafer 314 may be placed on the pedestal 316 and process gases are supplied from a gas panel 338 through entry ports 326 and form a gaseous mixture 350. The gaseous mixture 350 is ignited into a plasma 355 in the chamber 310 by applying power from the plasma source 318 to the antenna 312. Optionally, power from the bias source 322 may be also provided to the cathode 316. The pressure within the interior of the chamber 310 is controlled using a throttle valve 327 and a vacuum pump 336. The temperature of the chamber wall 330 is controlled using liquid-containing conduits (not shown) that run through the wall 330.

The temperature of the wafer 314 may be controlled by stabilizing a temperature of the support pedestal 316. In one embodiment, the helium gas from a gas source 348 is provided via a gas conduit 349 to channels formed by the back of the wafer 314 and grooves (not shown) in the pedestal surface. The helium gas is used to facilitate heat transfer between the pedestal 316 and the wafer 314. During the processing, the pedestal 316 may be heated by a resistive heater (not shown) within the pedestal to a steady state temperature and then the helium gas facilitates uniform heating of the wafer 314. Using such thermal control, the wafer 314 may be maintained at a temperature of between 0 and 500 degrees Celsius.

Those skilled in the art will understand that other forms of etch chambers may be modified in accordance with the teachings disclosed herein, including chambers with remote plasma sources, microwave plasma chambers, electron cyclotron resonance (ECR) plasma chambers, and the like.

The controller 340 comprises a central processing unit (CPU) 344, a memory 342, and support circuits 346 for the CPU 344 and facilitates control of the components of the etch process chamber 310 and, as such, of etch processes, such as discussed herein. The controller 340 may be one of any form of general-purpose computer processor that can be used in an industrial setting for controlling various chambers and sub-processors. The memory, or computer-readable medium, 342 of the CPU 344 may be one or more of readily available memory such as random access memory (RAM), read only memory (ROM), floppy disk, hard disk, or any other form of digital storage, local or remote. The support circuits 346 are coupled to the CPU 344 for supporting the processor in a conventional manner. These circuits include cache, power supplies, clock circuits, input/output circuitry and subsystems, and the like. The inventive method may be stored in the memory 342 as software routine and may be executed or invoked in the manner described above. The software routine may also be stored and/or executed by a second CPU (not shown) that is remotely located from the hardware being controlled by the CPU 344.

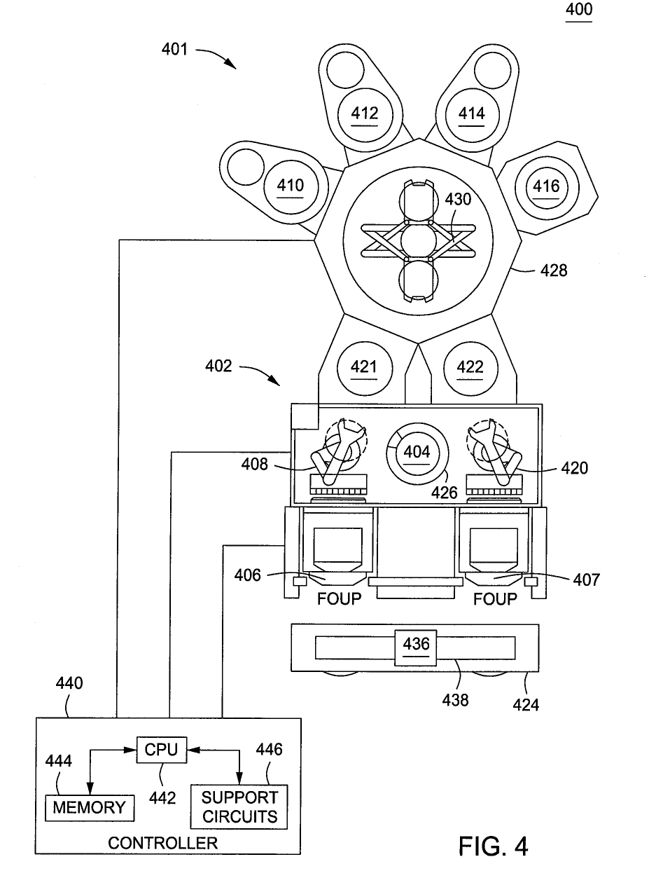

FIG. 4 depicts a schematic diagram of an exemplary integrated semiconductor substrate processing system (e.g., cluster tool) 400 of the kind used in one embodiment of the invention.

The system 400 illustratively includes a vacuum-tight processing platform 401, an input/output module 402, and a system controller 440. In one embodiment, the platform 401 comprises processing modules 410, 412, 414 and 416 and at least one load-lock chamber (load-lock chambers 421 and 422 are shown), which are coupled to a common vacuumed substrate transfer chamber 428.

The processing modules 410, 412, 414 and 416 may be any semiconductor processing module suitable for practicing the present invention including the semiconductor processing equipment described above.

The load-lock chambers 421 and 422 protect the transfer chamber 428 from atmospheric contaminants. The transfer chamber 428 comprises a substrate robot 430. In operation, the robot 430 transfers the substrates between the load lock chambers and processing modules. The depicted embodiment of the robot 430 is illustrative only.

The input/output module 402 comprises a metrology module 426, at least one docking station to accept one or more front opening unified pod (FOUP) (FOUPs 406 and 407 are shown) and at least one substrate robot (two robots 408 and 420 are shown). In one embodiment, the metrology module 426 comprises a measuring tool 404 employing at least one non-destructive measuring technique suitable for measuring critical dimensions of structures formed on the substrate. One suitable measuring tool 404 that optically measures critical dimensions is available from Nanometrics, located in Milpitas, Calif. The robots 408 and 420 transfer the pre-processed and post-processed substrates between the FOUPs 406, measuring tool 404, and load-lock chambers 421, 422. In the depicted embodiment, the metrology module 426 is used as a pass-through module. In other embodiments (not shown), the metrology module 426 may be a peripheral unit of the input/output module 402. The processing system having a measuring tool is disclosed, for example, in commonly assigned U.S. Pat. No. 6,150,664, issued Nov. 21, 2000, which is incorporated herein by reference.

The factory interface 424 is generally an atmospheric pressure interface used to transfer the cassettes with pre-processed and post-processed wafers disposed in the FOUPs 406, 407 between various processing systems and manufacturing regions of the semiconductor fab. Generally, the factory interface 424 comprises a substrate-handling device 436 and a track 438. In operation, the substrate-handling device 436 travels along the track 438 to transport the FOUPs between cluster tools or other processing equipment.

The system controller 440 is coupled to and controls modules and apparatus of the integrated processing system 400. The system controller 440 controls all aspects of operation of the system 400 using a direct control of modules and apparatus of the system 400 or, alternatively, by controlling the computers (or controllers) associated with these modules and apparatus. In operation, the system controller 440 enables data collection and feedback from the respective modules (e.g., metrology module 426) and apparatus that optimizes performance of the system 400.

The system controller 440 generally comprises a central processing unit (CPU) 442, a memory 444, and support circuits 446. The CPU 442 may be one of any form of a general purpose computer processor that can be used in an industrial setting. The support circuits 446 are conventionally coupled to the CPU 442 and may comprise cache, clock circuits, input/output subsystems, power supplies, and the like. The software routines, when executed by the CPU 442, transform the CPU into a specific purpose computer (controller) 440. The software routines may also be stored and/or executed by a second controller (not shown) that is located remotely from the system 400.

Embodiments of the inventive method described above may be stored in the memory 444 as software routine. The software routine may also be stored and/or executed by a second CPU (not shown) that is remotely located from the hardware being controlled by the CPU 442. In operation, the controller 440 may issue instructions to perform the inventive methods to the system 400 directly, or alternatively, via other computers or controllers (not shown) associated with the process chambers 410-416 and/or their support systems. Alternatively, as described above, the inventive methods may be contained on the controllers associated with the process chambers 410-416.

Thus, methods for performing predictive maintenance of semiconductor process equipment and self-aware semiconductor equipment adapted for performing the same have been provided herein. The methods may advantageously be performed on semiconductor equipment without a wafer being present. The methods may be used to assess whether the equipment is behaving erratically and requires maintenance or its behavior is predictable and thus ready for wafer processing. Embodiments of the present invention provide a means to assess the health of semiconductor equipment and guage the health of the tool, for example, within its life-cycle between cleaning operations. By factoring out wafer and recipe dependence on creating chamber “golden” signatures, the accuracy of fault detection may be improved dramatically. Moreover, the teachings of the present invention may be implemented in a non-customer/fab dependent manner, thereby facilitating uniform and reduced-cost implementation of such self-aware equipment and predictive maintenance technologies.

While the foregoing is directed to embodiments of the present invention, other and further embodiments of the invention may be devised without departing from the basic scope thereof, and the scope thereof is determined by the claims that follow.

1. A method for performing predictive maintenance on semiconductor processing equipment, comprising:
performing at least one self-diagnostic test on the semiconductor processing equipment with no substrate present in the equipment;
comparing a result of the at least one self diagnostic test to at least one baseline characterization of the equipment; and
determining whether equipment maintenance is required based upon the comparison.

2. The method of claim 1, wherein performing at least one self-diagnostic test comprises:
introducing one or more transients into the equipment.

3. The method of claim 2, wherein the transients comprise at least one of temperature variations of a substrate support pedestal or an electrostatic chuck, RF power variations of an RF source power or an RF bias power, gas flow rate variations of one or more gases introduced into the equipment, or process volume pressure variations.

4. The method of claim 2, wherein the at least one self diagnostic test further comprises:
monitoring the equipment to observe the effects of the one or more transients.

5. The method of claim 4, wherein monitoring the equipment is performed indirectly.

6. The method of claim 4, wherein monitoring the equipment is performed directly.

7. The method of claim 4, wherein performing at least one self-diagnostic test further comprises:
analyzing the observed data.

8. The method of claim 7, wherein analyzing the observed data further comprises:
statistically analyzing the observed data using at least one of a multivariant statistical technique, a nearest neighbor approach, a principal component analysis, or a least squares analysis.

9. The method of claim 2, wherein the one or more transients are introduced into the equipment sequentially, concurrently, partially overlapping, or sporadically.

10. The method of claim 1, wherein the at least one self-diagnostic test is performed during equipment idle time.

11. The method of claim 1, wherein the at least one self-diagnostic test is performed periodically based upon at least one of actual time elapsed between checks, equipment runtime elapsed, prior to introducing the first wafer into the equipment, between processing each wafer in the equipment, between processing wafer lots in the equipment, shift-to-shift changes of operators, between making changes in the process conditions in the equipment, or after chamber clean processes or other maintenance of the equipment.

12. The method of claim 1, wherein the equipment invokes the at least one self-diagnostic test automatically.

13. The method of claim 1, wherein the semiconductor processing equipment comprises one of an etch chamber, a deposition chamber, a thermal processing chamber, a plasma processing chamber, or a magnetically enhanced process chamber.

14. A computer readable medium having instructions stored thereon that, when executed by a processor, cause the processor to perform a method for predictive maintenance of semiconductor process equipment, comprising:
performing at least one self-diagnostic test on the semiconductor processing equipment with no substrate present in the equipment;
comparing a result of the at least one self diagnostic test to at least one baseline characterization of the equipment; and
determining whether equipment maintenance is required based upon the comparison.

15. The computer readable medium of claim 14, wherein the method for predictive maintenance of semiconductor process equipment further comprises:
introducing one or more transients into the equipment.

16. The computer readable medium of claim 15, wherein the method for predictive maintenance of semiconductor process equipment further comprises:
monitoring the equipment to observe the effects of the one or more transients; and
analyzing the observed data.

17. The computer readable medium of claim 16, wherein analyzing the observed data further comprises:
statistically analyzing the observed data using at least one of a multivariant statistical technique, a nearest neighbor approach, a principal component analysis, or a least squares analysis.

18. The computer readable medium of claim 15, wherein the transients comprise at least one of temperature variations of a substrate support pedestal or an electrostatic chuck, RF power variations of an RF source power or an RF bias power, gas flow rate variations of one or more gases introduced into the equipment, or process volume pressure variations.

19. A system for processing semiconductor substrates, comprising:
a process chamber; and
a controller coupled to the process chamber and configured to control the operation thereof, wherein the controller comprises computer readable medium having instructions stored thereon that, when executed by the controller, cause the controller to perform a method for predictive maintenance of the process chamber, comprising:
performing at least one self-diagnostic test on the semiconductor processing equipment with no substrate present in the equipment;
comparing a result of the at least one self diagnostic test to at least one baseline characterization of the equipment; and
determining whether equipment maintenance is required based upon the comparison.

20. The system of claim 19, wherein the method for predictive maintenance of semiconductor process equipment further comprises:
introducing one or more transients into the equipment.

21. The system of claim 20, wherein the method for predictive maintenance of semiconductor process equipment further comprises:
monitoring the equipment to observe the effects of the one or more transients; and
analyzing the observed data.

22. The system of claim 21, wherein analyzing the observed data further comprises:
statistically analyzing the observed data using at least one of a multivariant statistical technique, a nearest neighbor approach, a principal component analysis, or a least squares analysis.

23. The system of claim 20, wherein the transients comprise at least one of temperature variations of a substrate support pedestal or an electrostatic chuck, RF power variations of an RF source power or an RF bias power, gas flow rate variations of one or more gases introduced into the equipment, or process volume pressure variations.

24. The system of claim 19, wherein the process chamber comprises one of an etch chamber, a deposition chamber, a thermal processing chamber, a plasma processing chamber, or a magnetically enhanced process chamber.
